(19) United States
(12) Patent Application Publication
(10) Pub. No.: US 2024/0201650 A1
(43) Pub. Date: Jun. 20, 2024

(54) OPERATIONAL STATUS DISPLAY DEVICE AND COMPUTER-READABLE STORAGE MEDIUM

(71) Applicant: FANUC CORPORATION, Yamanashi (JP)

(72) Inventors: Yuuki SUGITA, Yamanashi (JP); Nobuaki AIZAWA, Yamanashi (JP)

(21) Appl. No.: 18/555,726

(22) PCT Filed: May 17, 2021
(86) PCT No.: PCT/JP2021/018639

§ 371 Date: Oct. 17, 2023

(51) Int. Cl. G05B 19/4065

(52) U.S. Cl. CPC G05B 19/4065; G05B 2219/37088

(57) ABSTRACT

This operational status display device comprises: an event setting table for storing event designation information that designates an event occurring in a machining machine, operational data identity information for identifying operational data on the machining machine, and extraction conditions for extracting feature data indicating the occurrence of an event from the operational data in association with each other; a first acquisition unit which acquires the operational data identity information and the extraction conditions, associated with the event designation information from the event setting table, on the basis of the event designation information; a second acquisition unit that acquires feature data from the operational data, on the basis of the operational data identity information and the extraction conditions acquired by the first acquisition unit; and a display unit which displays, on a display screen, the feature data acquired by the second acquisition unit.

### TECHNICAL FIELD

The present disclosure relates to an operational status display device and a computer readable storage medium.

### BACKGROUND ART

Techniques for acquiring operational data from a machining machine and analyzing an event that has occurred in the machining machine based on the acquired operational data are conventionally known. For example, when a chatter mark occurs in a workpiece machined by a machine tool, the use of the above technique makes it possible to review what load fluctuation has occurred in a spindle.

### CITATION LIST

### Patent Literature

Patent Literature 1: Japanese Patent Application Laid-Open No. 2019-139414

### SUMMARY OF INVENTION

### Technical Problem

However, many types of operational data are acquired from a machining machine, and the amount of each operational data also becomes enormous. Thus, finding a characteristic part representing an event that has occurred in a machining machine from the operational data will cause a significant burden for an operator.

The present disclosure intends to provide an operational status display device and a computer readable storage medium that make it possible to easily find a characteristic part representing an event that has occurred in a machining machine from operational data acquired in the machining machine.

### Solution to Problem

The operational status display device includes: an event setting table storing event designation information that designates an event occurring in a machining machine, operational data identity information that identifies operational data on the machining machine, and an extraction condition used for extracting feature data indicating occurrence of the event from the operational data, which are stored in association with each other; a first acquisition unit that, based on the event designation information, acquires the operational data identity information and the extraction condition associated with the event designation information from the event setting table; a second acquisition unit that acquires the feature data from the operational data based on the operational data identity information and the extraction condition acquired by the first acquisition unit; and a display unit that displays the feature data acquired by the second acquisition unit on a display screen.

The computer readable storage medium stores an instruction that causes a computer to perform: from an event setting table storing event designation information that designates an event occurring in a machining machine, operational data identity information that identifies operational data on the machining machine, and an extraction condition used for extracting feature data indicating occurrence of the event from the operational data, which are stored in association with each other, acquiring, based on the event designation information, the operational data identity information and the extraction condition associated with the event designation information; acquiring the feature data from the operational data based on the operational data identity information and the extraction condition; and displaying the acquired feature data on a display screen.

### Advantageous Effects of Invention

One aspect of the present disclosure makes it possible to easily find a characteristic part representing an event that has occurred in a machining machine from operational data acquired in the machining machine.

### BRIEF DESCRIPTION OF DRAWINGS

FIG. 1 is a diagram illustrating an example of a hardware configuration diagram of a machining machine.

FIG. 2 is a block diagram illustrating an example of functions of an operational status display device.

FIG. 3 is a diagram illustrating an example of an event setting table.

FIG. 4 is a diagram illustrating an example of an entry screen for event designation information.

FIG. 5 is a diagram illustrating a display example of feature data and an image.

FIG. 6 is a flowchart illustrating an example of a flow of a process performed by the operational status display device.

FIG. 7 is a block diagram illustrating an example of functions of the operational status display device.

FIG. 8 is a diagram illustrating acquisition of a display history.

FIG. 9 is a diagram illustrating setting of extraction conditions.

FIG. 10 is a diagram illustrating setting of extraction conditions.

FIG. 11 is a block diagram illustrating an example of functions of the operational status display device.

FIG. 12 is a diagram illustrating an example of an image capturing a part of a machining machine.

FIG. 13 is a diagram illustrating an example of an event setting table.

### DESCRIPTION OF EMBODIMENTS

One embodiment of the present disclosure will be described below with reference to the drawings. Note that not all of the combined features described in the following embodiment are necessarily required for achieving the object. Further, detailed description than is needed may be omitted. Further, the description and the drawings of the following embodiment are provided for those skilled in the art to fully understand the present disclosure and are not intended to limit the claims.

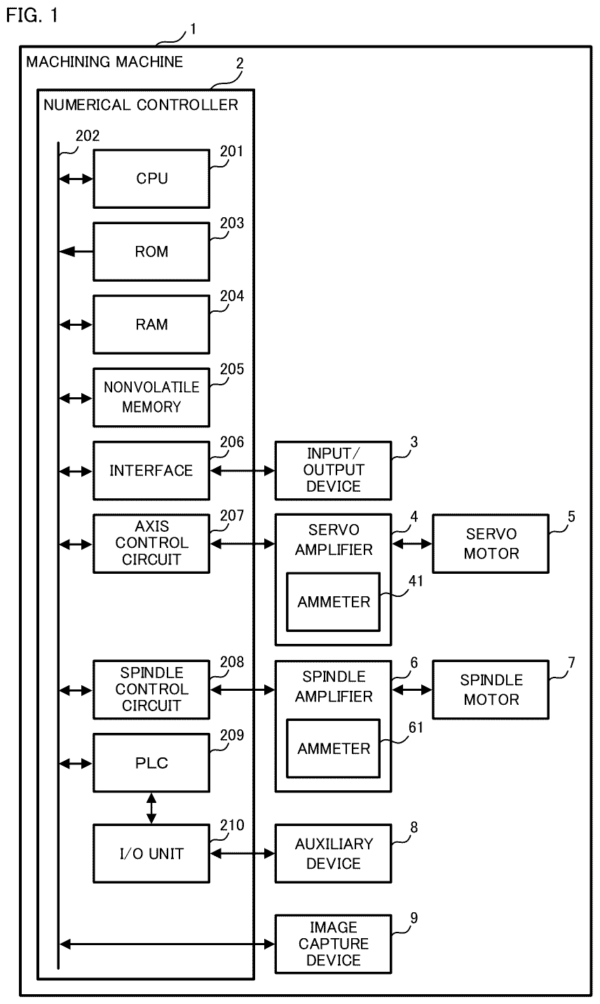

FIG. 1 is a diagram illustrating an example of a hardware configuration of a machining machine. For example, the machining machine 1 is a machine tool, a wire electrical discharge machine, or an injection molding machine. The machine tool includes a lathe, a machining center, and a multi-tasking machine.

The machining machine 1 includes a numerical controller 2, an input/output device 3, a servo amplifier 4 and a servo motor 5, a spindle amplifier 6 and a spindle motor 7, an auxiliary device 8, and an image capture device 9.

The numerical controller 2 has the function of the operational status display device of the present disclosure. That is, operational status display device implemented on the numerical controller 2. In the following, an embodiment in which the operational status display device is implemented on the numerical controller 2 will be described. However, the operational status display device may be implemented on a personal computer (PC) or a server.

The numerical controller 2 is a device that controls the overall machining machine 1. The numerical controller 2 has a central processing unit (CPU) 201, a bus 202, a read-only memory (ROM) 203, a random-access memory (RAM) 204, and a nonvolatile memory 205.

The CPU 201 is a processor that controls the overall numerical controller 2 in accordance with a system program. The CPU 201 reads a system program or the like stored in the ROM 203 via the bus 202 and performs various processes based on the system program. Further, the CPU 201 controls the servo motor 5 and the spindle motor 7 based on a machining program.

The CPU 201 performs, for example, analysis of a machining program and output of a control instruction to the servo motor 5 and the spindle motor 7 on a control cycle basis.

The bus 202 is a communication path connecting respective hardware components within the numerical controller 2 to each other. Respective hardware components within the numerical controller 2 transfer data to each other via the bus 202.

The ROM 203 is a storage device that stores a system program or the like used for controlling the overall numerical controller 2. The ROM 203 is a computer readable storage medium.

The RAM 204 is a storage device that temporarily stores various data. The RAM 204 functions as a work area where the CPU 201 processes various data.

The nonvolatile memory 205 is a storage device that holds data even when the machining machine 1 is powered off and the numerical controller 2 is not supplied with power. For example, the nonvolatile memory 205 stores a machining program and stores various parameters input from the input/output device 3. The nonvolatile memory 205 is a computer readable storage medium. The nonvolatile memory 205 is formed of a solid state drive (SSD), for example.

The numerical controller 2 further includes an interface 206, an axis control circuit 207, a spindle control circuit 208, a programmable logic controller (PLC) 209, and an I/O unit 210.

The interface 206 connects the bus 202 and the input/output device 3 to each other. For example, the interface 206 transmits various data processed by the CPU 201 to the input/output device 3.

The input/output device 3 is a device that receives various data via the interface 206 and displays the various data. Further, the input/output device 3 accepts input of various data and transmits the various data to the CPU 201 via the interface 206. The input/output device 3 includes a display such as a liquid crystal display (LCD), a keyboard, a mouse, and the like. The input/output device 3 may instead be a touch panel.

The axis control circuit 207 is a circuit that controls the servo motor 5. The axis control circuit 207 outputs an instruction for driving the servo motor 5 to the servo amplifier 4 in response to a control instruction from the CPU 201. For example, the axis control circuit 207 transmits a torque command used for controlling the torque of the servo motor 5 to the servo amplifier 4.

The servo amplifier 4 supplies current to the servo motor 5 in response to an instruction from the axis control circuit 207. The servo amplifier 4 has an ammeter 41 built in that measures a current value of current supplied to the servo motor 5.

The ammeter 41 determines a current value of current supplied to the servo motor 5. The ammeter 41 transmits data indicating a determined current value to the CPU 201.

The servo motor 5 is driven in response to being supplied with current from the servo amplifier 4. For example, the servo motor 5 is coupled to a ball screw that drives a tool post. When the servo motor 5 is driven, a structure of the machining machine 1, such as a tool post, moves in the X-axis direction, the Y-axis direction, or the Z-axis direction, for example. Note that a speed detector (not illustrated) that determines the feed rate of each control axis may be built in the servo motor 5.

The spindle control circuit 208 is a circuit for controlling the spindle motor 7. The spindle control circuit 208 outputs an instruction for driving the spindle motor 7 to the spindle amplifier 6 in response to a control instruction from the CPU 201. For example, the spindle control circuit 208 transmits a torque command used for controlling the torque of the spindle motor 7 to the spindle amplifier 6.

The spindle amplifier 6 supplies current to the spindle motor 7 in response to an instruction from the spindle control circuit 208. The spindle amplifier 6 has an ammeter 61 built in that measures a current value of current supplied to the spindle motor 7.

The ammeter 61 determines a current value of current supplied to the spindle motor 7. The ammeter 61 transmits data indicating a determined current value to the CPU 201.

The spindle motor 7 is driven in response to current supply from the spindle amplifier 6. The spindle motor 7 is coupled to a spindle and rotates the spindle.

The PLC 209 is a device that executes a ladder program to control the auxiliary device 8. The PLC 209 transmits an instruction to the auxiliary device 8 via the I/O unit 210.

The I/O unit 210 is an interface that connects the PLC 209 and the auxiliary device 8 to each other. The I/O unit 210 transmits an instruction received from the PLC 209 to the auxiliary device 8.

The auxiliary device 8 is a device installed in the machining machine 1 and configured to perform auxiliary operations in the machining machine 1. The auxiliary device 8 may be a device installed around the machining machine 1. The auxiliary device 8 operates based on an instruction received from the I/O unit 210. The auxiliary device 8 is, for example, a tool changer, a cutting fluid injector, or an opening/closing door drive device.

The image capture device 9 is a device that captures an image of the whole or a part of the machining machine 1. The image capture device 9 is a camera that captures moving images and still images. For example, the image capture device 9 starts capturing a moving image at a timing that execution of a machining program is started. For example, the image capture device 9 captures an image of a machining region of the machining machine 1.

For example, an image acquired by the image capture device 9 is stored in the nonvolatile memory 205 via the bus 202. Further, the image capture device 9 acquires time information together with an image. For example, the time information is a time of image capturing being performed or an elapsed time from start of image capturing.

Next, an example of functions of the operational status display device implemented on the numerical controller 2 will be described.

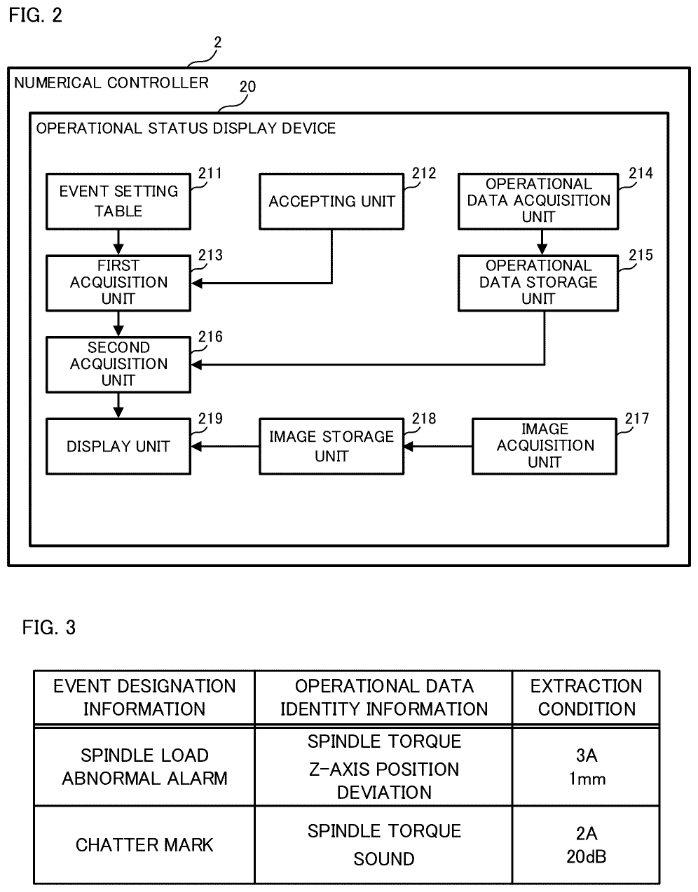

FIG. 2 is a block diagram illustrating an example of the functions of the operational status display device. A operational status display device 20 includes an event setting table 211, an accepting unit 212, a first acquisition unit 213, an operational data acquisition unit 214, an operational data storage unit 215, a second acquisition unit 216, an image acquisition unit 217, an image storage unit 218, and a display unit 219.

The event setting table 211 and the operational data storage unit 215 are implemented when data and parameters input from the input/output device 3 and various sensors (not illustrated) installed in the machining machine 1 are stored in the RAM 204 or the nonvolatile memory 205, for example. The image storage unit 218 is implemented when an image acquired from the image capture device 9 is stored in the nonvolatile memory 205.

The accepting unit 212, the first acquisition unit 213, the operational data acquisition unit 214, the second acquisition unit 216, the image acquisition unit 217, and the display unit 219 are implemented when the CPU 201 performs calculation processing by using a system program stored in the ROM 203 and various data stored in the nonvolatile memory 205.

The event setting table 211 is a table storing event designation information that designates an event occurring in the machining machine 1, operational data identity information that identifies operational data on the machining machine 1, and extraction conditions used for extracting feature data indicating occurrence of an event from operational data, which are stored in association with each other.

The event occurring in the machining machine 1 is, for example, an event indicating an abnormality occurring during an operation of the machining machine 1. The event occurring in the machining machine 1 includes a spindle load abnormal alarm, an abnormal vibration alarm, a chatter event, and an opening/closing abnormal alarm of an opening/closing door.

The event designation information is a name of an event occurring in the machining machine 1. The event designation information functions as an index in acquisition of operational data identity information and an extraction condition.

The operational data is time-series data acquired from a sensor or the like installed in the machining machine 1 during an operation of the machining machine 1. The operational data is acquired on a predetermined period basis. The operational data includes torque data on a spindle, torque data on each control axis, a position deviation on each control axis, sound data, vibration data, and opening/closing confirmation signal data on an opening/closing door.

The operational data identity information is a name of operational data, for example. The operational data identity information functions as an index in acquisition of operational data.

The feature data is characteristic data appearing in operational data when an event occurs in the machining machine 1. The feature data is, for example, operational data indicating a value that is greater than or equal to a predetermined threshold. Further, the feature data is operational data indicating a predetermined time-series pattern. Specific examples of the feature data will be described later in detail.

The extraction condition is a condition for extracting feature data from operational data. The extraction condition includes numerical data or a time-series pattern. When the extraction condition is numerical data, for example, operational data indicating a value that is greater than or equal to the numerical data is the feature data. Further, when the extraction condition is a time-series pattern, operational data matching or similar to a time-series pattern set as the extraction condition is the feature data. For example, the extraction condition is set in advance by a manufacturer of the operational status display device 20 or an operator. Further, as described later, the extraction condition may be automatically set by the operational status display device 20.

FIG. 3 is a diagram illustrating an example of the event setting table 211. The event setting table 211 stores “Spindle load abnormal alarm” and “Chatter mark” as the event designation information.

The spindle load abnormal alarm is an alarm occurring when the torque value of the spindle increases due to damage of a tool or the like. The chatter mark is a wavelike mark appearing on the surface of a workpiece due to abnormal vibration of the tool or the workpiece during machining.

The event setting table 211 stores “Spindle torque” and “Z-axis position deviation” as the operational data identity information in association with “Spindle load abnormal alarm”. Further, the event setting table 211 stores “Spindle torque” and “Sound” as the operational data identity information in association with “Chatter mark”. Note that the position deviation is a difference between an instruction value for instruction of a position of a control axis and a detected value indicating the position of the control axis.

Further, the event setting table 211 stores “3 A” and “1 mm” as the extraction conditions corresponding to “Spindle torque” and “Z-axis position deviation”, respectively. Further, the event setting table 211 stores “2 A” and “20 dB” as the extraction conditions corresponding to “Spindle torque” and “Sound”, respectively. Note that, since spindle torque is proportional to the value of current supplied to the spindle motor, the spindle torque is expressed by a value of current herein.

The accepting unit 212 accepts input of event designation information. For example, the event designation information is input by the operator from the input/output device 3.

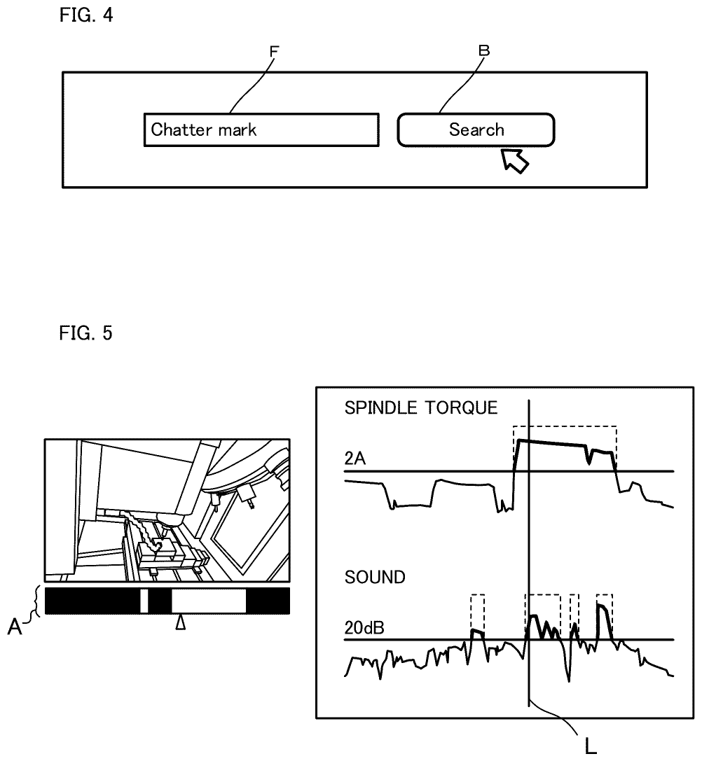

FIG. 4 is a diagram illustrating an example of an entry screen for event designation information. A designation information entry field F and a search button B are displayed in the entry screen. Once event designation information is input in the designation information entry field F and the search button B is pressed, the accepting unit 212 accepts the input of the event designation information. For example, the operator may input a word such as “spindle load abnormal alarm”, “chatter mark”, or the like in the designation information entry field F. Now turning back to the description of FIG. 2.

The first acquisition unit 213 acquires operational data identity information and an extraction condition associated with event designation information from the event setting table 211 based on event designation information.

For example, when the accepting unit 212 accepts a “spindle load abnormal alarm” word of as the event designation information, the first acquisition unit 213 acquires the operational data identity information “Spindle torque” and “Z-axis position deviation” and the extraction conditions “3 A” and “1 mm” associated with the “Spindle load abnormal alarm”.

When the accepting unit 212 accepts a word of “chatter mark” as the event designation information, the first acquisition unit 213 acquires the operational data identity information “Spindle torque” and “Sound” and the extraction conditions “2 A” and “20 dB” associated with the “Chatter mark”.

Note that the accepting unit 212 is not necessarily required to accept the same word as the event designation information stored in the event setting table 211. When the word accepted by the accepting unit 212 does not match the event designation information stored in the event setting table 211, the first acquisition unit 213 identifies event designation information similar to the word accepted by the accepting unit 212 and acquires operational data identity information and condition an extraction stored in association with the identified event designation information.

The operational data acquisition unit 214 acquires operational data from a sensor installed in the machining machine 1. The operational data acquisition unit 214 acquires operational data on a predetermined period basis. That is, the operational data is time-series data.

The operational data acquisition unit 214 acquires time information together with operational data. The time information is, for example, a time of acquisition of operational data or an elapsed time from a time of the machining machine 1 starting an operation. The time of the machining machine 1 starting an operation is, for example, a time of powering on the machining machine 1 or a time of start of execution of a machining program.

The operational data storage unit 215 stores operational data on the machining machine 1 acquired by the operational data acquisition unit 214. The operational data storage unit 215 stores the operational data acquired by the operational data acquisition unit 214 in association with time information.

The second acquisition unit 216 acquires feature data from operational data based on the operational data identity information and the extraction condition acquired by the first acquisition unit 213.

It is assumed that the operational data identity information acquired by the first acquisition unit 213 is “Spindle torque” and “Z-axis position deviation” and the extraction conditions are “3 A” and “1 mm” (see FIG. 3). In such a case, the second acquisition unit 216 first acquires the time-series data indicating the spindle torque and the time-series data indicating the Z-axis position deviation stored in the operational data storage unit 215.

Next, the second acquisition unit 216 identifies feature data satisfying the extraction condition out of the time-series data indicating the spindle torque. The extraction condition of the spindle torque is “3 A”. Therefore, the second acquisition unit 216 identifies time-series data indicating 3 [A] or larger out of the time-series data indicating the spindle torque. That is, the time-series data indicating 3 [A] or larger out of the time-series data indicating the spindle torque is the feature data.

Further, the second acquisition unit 216 identifies feature data satisfying the extraction condition out of the time-series data indicating the Z-axis position deviation. The extraction condition of the Z-axis position deviation is “1 mm”. Therefore, the second acquisition unit 216 identifies time-series data indicating 1 [mm] or larger out of the time-series data indicating the Z-axis position deviation. That is, the time-series data indicating 1 [mm] or larger out of the time-series data indicating the Z-axis position deviation is the feature data.

It is assumed that the operational data identity information acquired by the first acquisition unit 213 represents “Spindle torque” and “Sound” and the extraction conditions are “2 A” and “20 dB” (see FIG. 3). In such a case, the second acquisition unit 216 first acquires the time-series data indicating the spindle torque and the time-series data indicating the sound stored in the operational data storage unit 215.

Next, the second acquisition unit 216 identifies feature data satisfying the extraction condition out of the time-series data indicating the spindle torque. The extraction condition of the spindle torque is “2 A”. Therefore, the second acquisition unit 216 identifies time-series data indicating 2 [A] or larger out of the time-series data indicating the spindle torque. That is, the time-series data indicating 2 [A] or larger out of the time-series data indicating the spindle torque is the feature data.

Further, the second acquisition unit 216 identifies feature data satisfying the extraction condition out of the time-series data indicating the sound. The extraction condition of the sound is “20 dB”. Therefore, the second acquisition unit 216 identifies time-series data indicating 20 [dB] or larger out of the time series data indicating the sound. That is, the time-series data indicating 20 [dB] or larger out of the time-series data indicating the sound is the feature data.

The image acquisition unit 217 acquires an image capturing the machining machine 1. The image acquired by the image acquisition unit 217 includes a moving image. The image acquisition unit 217 acquires an image from the image capture device 9 that captures an image of a part or the whole of the machining machine 1. The image acquisition unit 217 acquires time information together with the image capturing the machining machine 1. The time information represents a time of image capturing being performed or an elapsed time from start of image capturing.

The image storage unit 218 stores an image acquired by the image acquisition unit 217. The image storage unit 218 stores an image in association with time information.

The display unit 219 displays feature data acquired by the second acquisition unit 216 and an image corresponding to the feature data on a display screen.

FIG. 5 is a diagram illustrating a display example of feature data and an image. FIG. 5 illustrates an example when an accepting unit 212 accepts “chatter mark” as the event designation information. The display unit 219 displays time-series data on spindle torque and time-series data on sound on the display screen. Further, the display unit 219 highlights the feature data identified by the second acquisition unit 216 out of the time-series data on spindle torque and the time-series data on sound. Highlighting feature data means, for example, expressing a part indicating the feature data with a bolder line or higher brightness line than the remaining part.

Further, the display unit 219 displays an image corresponding to the time-series data on spindle torque and the time-series data on sound on the display screen. By utilizing the time information stored in association with the time-series data on spindle torque and the time-series data on sound and the time information stored in association with the image, the display unit 219 displays the time-series data on spindle torque and the time-series data on sound and also the image in association with each other.

For example, once a play button of the image is pressed, the display unit 219 plays and displays the image and moves a straight line L to the right, where the line L indicates the position of each time-series data acquired when the image being played was captured. Accordingly, the display unit 219 can display the time-series data on spindle torque and the time-series data of sound data in association with the image being played.

Further, when the straight line L is moved laterally on the display screen by the operator's operation, the display unit 219 plays an image captured when the time-series data at the position pointed by the straight line was acquired. That is, the image corresponding to time-series data is an image captured at the same time as a time of acquisition of the time-series data.

The display unit 219 may display a playback status display region A indicating the playback status of an image on the display screen. The playback status display region A is a display region indicating a playback position of an image when the image is played. For example, a seek bar is displayed in the playback status display region A.

The display unit 219 may highlight a playback position of an image corresponding to feature data in the playback status display region A. When a seek bar is displayed in the playback status display region A, the display unit 219 displays a position corresponding to feature data on the seek bar in a different color from the remaining part or at a different brightness from the remaining part. This can highlight a playback position of an image corresponding to feature data.

Next, a flow of the process performed by the operational status display device 20 will be described.

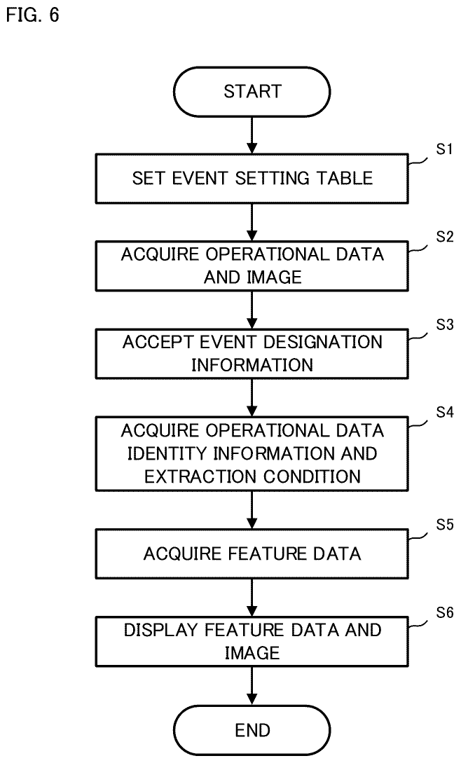

FIG. 6 is flowchart illustrating an example of a flow of the process performed by the operational status display device 20. First, when a workpiece is machined by the machining machine 1, setup of the event setting table 211 is performed (step S1). That is, event designation information, operational data identity information, and extraction conditions are stored in association with each other in the event setting table 211.

Next, operational data and images are acquired during an operation of the machining machine 1 (step S2). The acquired operational data and images are stored in the operational data storage unit 215 and the image storage unit 218, respectively.

Next, the accepting unit 212 accepts the event designation information input to the designation information entry field F (step S3).

Next, the first acquisition unit 213 acquires operational data identity information and an extraction condition associated with the event designation information from the event setting table 211 (step S4).

Next, the second acquisition unit 216 acquires feature data from the operational data (step S5).

Next, the display unit 219 displays the feature data and an image of the machining machine 1 on the display screen (step S6) and ends the process.

Note that, although the display unit 219 displays an image of the machining machine 1 together with operational data on the display screen in the embodiment described above, the image of the machining machine 1 is not necessarily required to be displayed, and only the operational data may be displayed. In such a case, the operational status display device 20 is not required to include the image acquisition unit 217 and the image storage unit 218.

As described above, the operational status display device 20 includes: the event setting table 211 storing event designation information that designates an event occurring in the machining machine 1, operational data identity information that identifies operational data on the machining machine 1, and an extraction condition used for extracting feature data indicating occurrence of the event from the operational data, which are stored in association with each other; the first acquisition unit 213 that, based designation on the event information, acquires the operational data identity information and the extraction condition associated with the event designation information from the event setting table 211; a second acquisition unit 216 that acquires the feature data from the operational data based on the operational data identity information and the extraction condition acquired by the first acquisition unit 213; and a display unit 219 that displays the feature data acquired by the second acquisition unit 216 on a display screen.

Therefore, the operator is able to easily review operational data when an event occurs in the machining machine 1.

Further, the operational status display device 20 further includes an image acquisition unit 217 that acquires an image capturing the machining machine 1, and the display unit 219 displays the feature data and the image corresponding to the feature data on the display screen. Therefore, the operator is able to easily review operational data and an image when an event occurs in the machining machine 1.

Further, the display unit 219 displays a playback status display region A indicating playback status of the image on the display screen and highlights a playback position of the image corresponding to the feature data in the playback status display region A. Therefore, the operator is able to easily find an image captured when an event occurs in the machining machine 1.

Further, the operational status display device 20 further includes an accepting unit 212 that accepts input of the event designation information, and based on the event designation information accepted by the accepting unit 212, the first acquisition unit 213 acquires the operational data identity information and the extraction condition associated with the event designation information from the event setting table 211. Therefore, the operational status display device 20 can quickly display an image and feature data to be reviewed by the operator in accordance with an event that has occurred in the machining machine 1.

The operational status display device 20 may further include: a display history acquisition unit that acquires a display history of the image and the operational data displayed on the display screen; and an event setting unit that sets the extraction condition in the event setting table 211 based on the display history acquired by the display history acquisition unit.

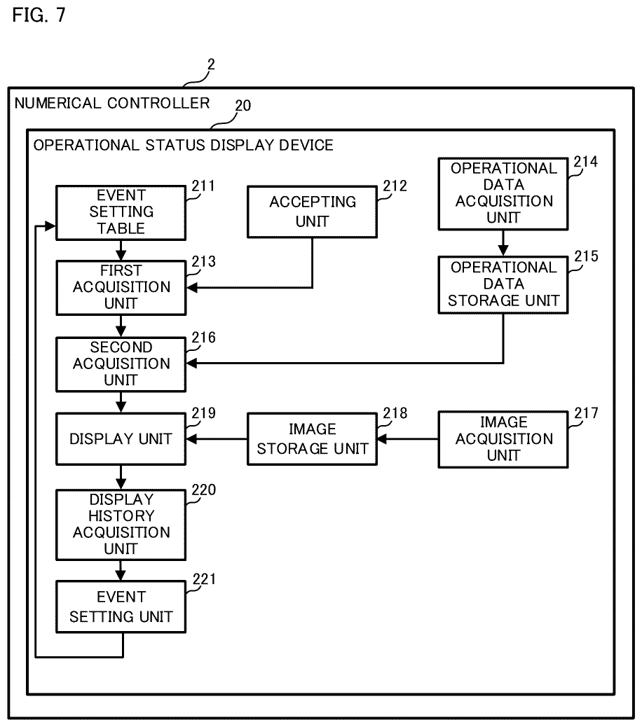

FIG. 7 is a block diagram illustrating an example of functions of the operational status display device 20. The operational status display device 20 further includes a display history acquisition unit 220 and an event setting unit 221 in addition to the functions illustrated in FIG. 2. Since the functions other than the display history acquisition unit 220 and the event setting unit 221 are the same as those in the operational status display device 20 illustrated in FIG. 2, the description thereof will be omitted.

The display history acquisition unit 220 acquires a display history of images and operational data about the machining machine 1 displayed on the display screen.

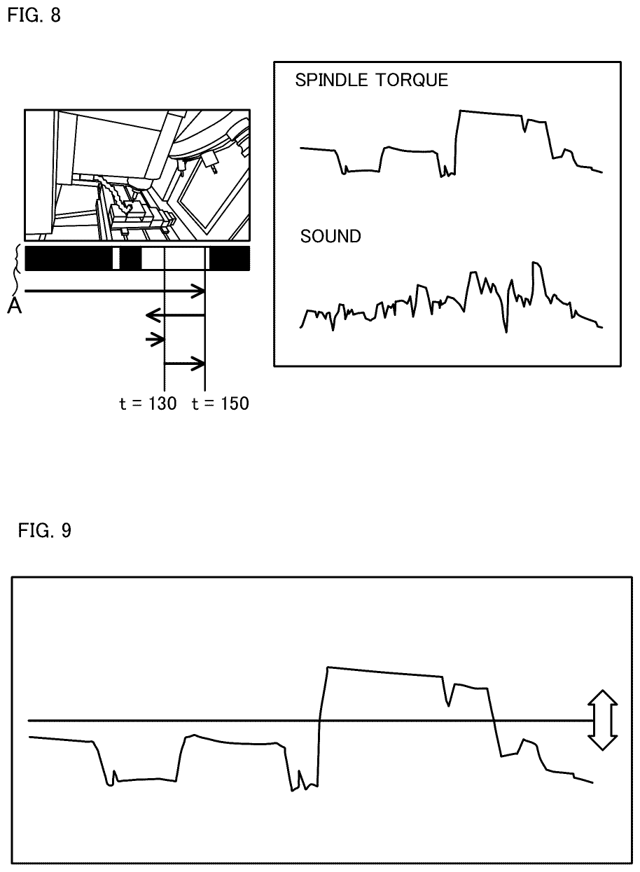

FIG. 8 is a diagram illustrating acquisition of a display history. When some event occurs in the machining machine 1 and the operator checks feature data together with an image illustrating the event, images within a time range in which the event seems to have occurred are repeatedly played. The display history acquisition unit 220 cuts out time-series data of the time range which has been repeatedly played. In the example illustrated in FIG. 8, images within the time range of t=130 to 150 [s] are repeatedly played. Therefore, the display history acquisition unit 220 acquires a time-series pattern of spindle torque and a time-series pattern of sound corresponding to t=130 to 150 [s].

The event setting unit 221 sets an extraction condition in the event setting table 211 based on a display history acquired by the display history acquisition unit 220.

The event setting unit 221 stores, in the event setting table 211, operational data identity information that identifies operational data that is displayed on the display screen. In the example illustrated in FIG. 8, “spindle torque” and “sound” are stored in the event setting table 211 as the operational data identity information.

Next, the event setting unit 221 sets a time-series pattern acquired by the display history acquisition unit 220 as an extraction condition. That is, the event setting unit 221 stores the time-series pattern cut out by the display history acquisition unit 220 in the event setting table 211 as the extraction condition.

Finally, event designation information is input by the operator, and the input event designation information is stored in association with the operational data identity information and the extraction condition. Accordingly, the extraction condition is automatically set in the event setting table 211.

Note that the event setting unit 221 may set, as an extraction condition, a mean value or a standard deviation indicated by a time-series pattern acquired by the display history acquisition unit 220.

Further, the event setting unit 221 may set the extraction condition in the event setting table 211 based on an operation performed on operational data displayed on the display screen.

FIG. 9 is a diagram illustrating an example in which an extraction condition is set based on an operation performed on operational data. For example, the event setting unit 221 displays a single horizontal line superimposed on operational data based on a predetermined operation performed on the input/output device 3 by the operator.

Once the horizontal line is displayed on the display screen, the operator moves the horizontal line to a position corresponding to a numerical value set as an extraction condition. In response to completion of the motion of the horizontal line by the operator, the event setting unit 221 sets a numerical value indicated by the position of the horizontal line as the extraction condition.

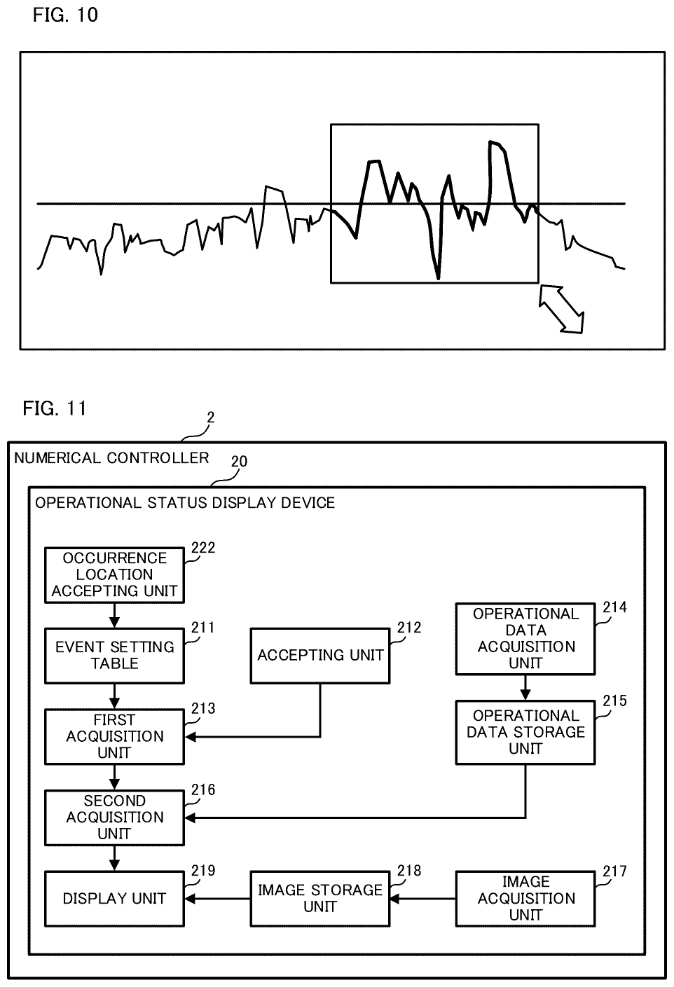

FIG. 10 is a diagram illustrating another example in which an extraction condition is set based on an operation performed on operational data. For example, the event setting unit 221 displays a single rectangular frame superimposed on the operational data based on a predetermined operation performed on the input/output device 3 by the operator.

Once the frame is displayed on the display screen, the operator moves the frame to a position superimposed on a time-series pattern set as an extraction condition. In response to completion of the motion of the frame, the event setting unit 221 sets a time-series pattern surrounded by the frame as the extraction condition. The event setting unit 221 may set, as an extraction condition, a mean value or a standard deviation indicated by the time-series pattern surrounded by the frame. Further, the size of the frame may be variable.

In the embodiment described above, the operational status display device 20 displays feature data and an image on the display screen based on event designation information accepted by the accepting unit 212. However, the operational status display device 20 may further include an occurrence location accepting unit that accepts designation of an occurrence location of an event and may display feature data and an image of the machining machine 1 on the display screen based on the occurrence location of the event accepted by the occurrence location accepting unit.

FIG. 11 is a diagram illustrating an example of functions of the operational status display device 20 including the occurrence location accepting unit. The functions other than an occurrence location accepting unit 222 are the same as the functions of the operational status illustrated in FIG. 2. Thus, the display device 20 description of the functions other than the occurrence location accepting unit 222 will be omitted.

The occurrence location accepting unit 222 accepts designation of an occurrence location of an event. For example, the occurrence location accepting unit 222 accepts designation of an occurrence location of an event based on designation of a position on an image of the machining machine 1 displayed on the display screen. To enable designation of an occurrence location of an event to be accepted by the occurrence location accepting unit 222, the display unit 219 displays an image capturing a part or the whole of the machining machine 1, for example, on the display screen.

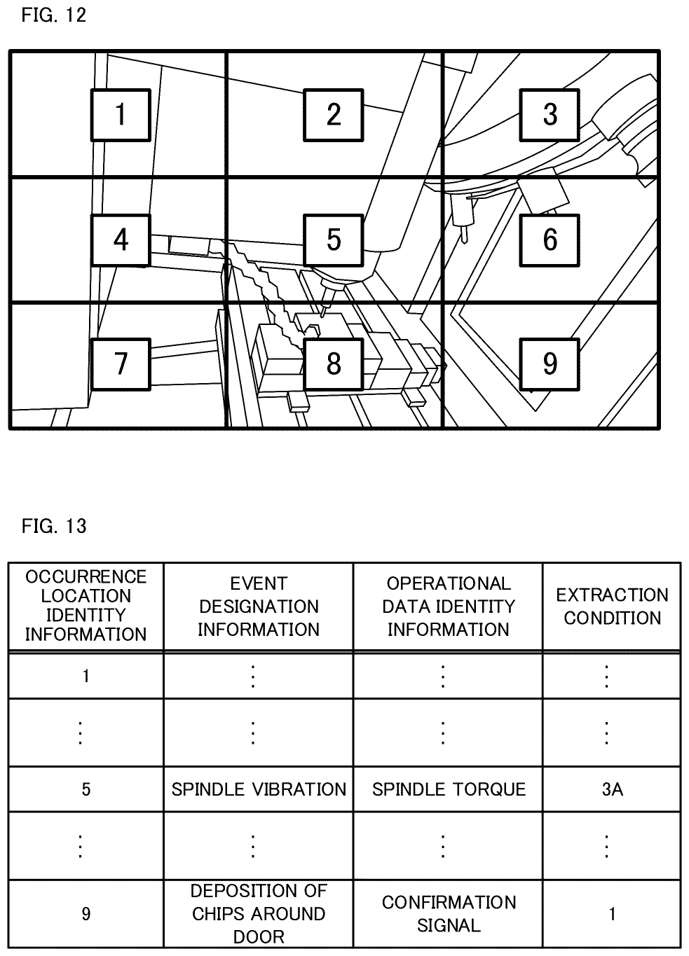

FIG. 12 is a diagram illustrating an example of an image capturing a part of the machining machine 1 displayed on the display screen. The display unit 219 divides an image into a plurality of regions in the display. For example, the display unit 219 divides an image into nine regions 1 to 9 in the display.

The occurrence location accepting unit 222 accepts designation of an occurrence location in response to selection of one region of the plurality of regions displayed on the display screen.

Occurrence location identity information that identifies an occurrence location of an event is stored in the event setting table 211 in association with event designation information, operational data identity information, and an extraction condition.

FIG. 13 is a diagram illustrating an example of the event setting table 211. In the event setting table 211, numbers 1 to 9 are set as the occurrence location identity information. The numbers 1 to 9 set in the event setting table 211 correspond to the regions 1 to 9, respectively.

A spindle is imaged in the region 5 in the image illustrated in FIG. 12. Therefore, event designation information related to the spindle is stored for the occurrence location identity information No. 5. For example, the event designation information related to the spindle is “Spindle vibration”. Further, as operational data identity information, “Spindle torque” is stored in association with “Spindle vibration”. Further, as an extraction condition, “3 A” is stored in association with “Spindle torque”.

An opening/closing door is imaged in the region 9 in the image illustrated in FIG. 12. Therefore, event designation information related to the opening/closing door is stored for the occurrence location identity information No. 9. For example, the event designation information related to the opening/closing door is “Deposition of chips around door”. As operational data identity information, “Confirmation signal” is stored in association with “Deposition of chips around door”. As an extraction condition, “1” is stored in association with “Confirmation signal”. When a signal indicating completion of an opening operation or a closing operation of the door is not output even after a predetermined time has elapsed from output of an opening signal or a closing signal that is an instruction of the opening operation or the closing operation of the door, “1” is output as the confirmation signal.

The display unit 219 divides the image of the machining machine 1 into nine regions 1 to 9 in the display, and for example, it is assumed that the region 9 is designated by the operator. In this case, the occurrence location accepting unit 222 accepts No. 9 as the occurrence location identity information. Further, the first acquisition unit 213 acquires “Confirmation signal” as the operational data identity information and “1” as the extraction condition from the event setting table 211 based on the occurrence location identity information accepted by the occurrence location accepting unit 222.

Next, the second acquisition unit 216 acquires feature data satisfying the extraction condition “1” from the operational data indicating the confirmation signal.

Finally, the display unit 219 displays feature data on the display screen. At this time, the display unit 219 displays the image of the machining machine 1 corresponding to the feature data side by side with the feature data. This enables the operator to review operational data and an image of the point of time when an opening or closing operation of the opening/closing door is interrupted due to deposition of chips around the door.

As described above, the operational status display device 20 further includes an occurrence location accepting unit 222 that accepts designation of an occurrence location of the event, the event setting table 211 further stores occurrence location identity information that identifies the occurrence location in association with the event designation information, the operational data identity information, and the extraction condition, and based on the occurrence location identity information accepted by the occurrence location unit accepting 222, the first acquisition unit 213 acquires the operational data identity information and the extraction condition associated with the occurrence location identity information that identifies the occurrence location from the event setting table 211.

Further, the occurrence location accepting unit 222 accepts designation of the occurrence location when one region of a plurality of regions in the image displayed on the display screen is selected.

Therefore, the operator is able to cause the feature data on a structure imaged in a selected image to be displayed by only selecting one region in an image of the machining machine 1 displayed on the display screen.

Note that the present disclosure is not limited to the embodiment described above and can be changed as appropriate within the scope not departing from the spirit thereof. In the present disclosure, modification of any component of the embodiment or omission of any component of the embodiment is possible.

### LIST OF REFERENCE SYMBOLS

1 machining machine
2 numerical controller
20 operational status display device
201 CPU
202 bus
203 ROM
204 RAM
205 nonvolatile memory
206 interface
207 axis control circuit
208 spindle control circuit
209 PLC
210 I/O unit
211 event setting table
212 accepting unit
213 first acquisition unit
214 operational data acquisition unit
215 operational data storage unit
216 second acquisition unit
217 image acquisition unit
218 image storage unit
219 display unit
220 display history acquisition unit
221 event setting unit
222 occurrence location accepting unit
3 input/output device
4 servo amplifier
41 ammeter
5 servo motor
6 spindle amplifier
61 ammeter
7 spindle motor
8 auxiliary device
6 image capture device

1. An operational status display device comprising:
an event setting table storing event designation information that designates an event occurring in a machining machine, operational data identity information that identifies operational data on the machining machine, and an extraction condition used for extracting feature data indicating occurrence of the event from the operational data, which are stored in association with each other;
a first acquisition unit that, based on the event designation information, acquires the operational data identity information and the extraction condition associated with the event designation information from the event setting table;
a second acquisition unit that acquires the feature data from the operational data based on the operational data identity information and the extraction condition acquired by the first acquisition unit; and
a display unit that displays the feature data acquired by the second acquisition unit on a display screen.

2. The operational status display device according to claim 1 further comprising an image acquisition unit that acquires an image capturing the machining machine,
wherein the display unit displays the feature data and the image corresponding to the feature data on the display screen.

3. The operational status display device according to claim 2, wherein the display unit displays a playback status display region indicating playback status of the image on the display screen and highlights a playback position of the image corresponding to the feature data in the playback status display region.

4. The operational status display device according to claim 2 further comprising:
a display history acquisition unit that acquires a display history of the image and the operational data displayed on the display screen; and
an event setting unit that sets the extraction condition in the event setting table based on the display history acquired by the display history acquisition unit.

5. The operational status display device according to claim 2 further comprising an event setting unit that sets the extraction condition in the event setting table based on an operation performed on the operational data displayed on the display screen.

6. The operational status display device according to claim 2 further comprising an occurrence location accepting unit that accepts designation of an occurrence location of the event,
wherein the event setting table further stores occurrence location information indicating the occurrence location in association with the event designation information, the operational data identity information, and the extraction condition, and
wherein based on the designation of the occurrence location accepted by the occurrence location accepting unit, the first acquisition unit acquires the operational data identity information and the extraction condition associated with the occurrence location information from the event setting table.

7. The operational status display device according to claim 6, wherein the occurrence location accepting unit accepts designation of the occurrence location when one region of a plurality of regions of the image displayed on the display screen is selected.

8. The operational status display device according to claim 1 further comprising an accepting unit that accepts input of the event designation information,
wherein based on the event designation information accepted by the accepting unit, the first acquisition unit acquires the operational data identity information and the extraction condition associated with the event designation information from the event setting table.

9. The operational status display device according to claim 1, wherein the extraction condition includes at least any one of numerical data and a time-series pattern.

10. A computer readable storage medium storing an instruction that causes a computer to perform:
from an event setting table storing event designation information that designates an event occurring in a machining machine, operational data identity information that identifies operational data on the machining machine, and an extraction condition used for extracting feature data indicating occurrence of the event from the operational data, which are stored in association with each other, acquiring, based on the event designation information, the operational data identity information and the extraction condition associated with the event designation information;
acquiring the feature data from the operational data based on the operational data identity information and the extraction condition; and
displaying the acquired feature data on a display screen.
